(19) United States
(12) Patent Application Publication
(10) Pub. No.: US 2026/0104284 A1
(43) Pub. Date: Apr. 16, 2026

(54) Valve with Magnetically Actuated Indicator

(71) Applicant: Eco-Values Ltd., (IL)

(72) Inventors: Reuven PEREZ, Kibbutz Kfar Masaryk (IL); Hen BENJAMIN, Kibbutz Kfar Masaryk (IL)

(21) Appl. No.: 18/914,361

(22) Filed: Oct. 14, 2024

(51) Int. Cl. G01F 23/62; B01D 17/02

(52) U.S. Cl. CPC G01F 23/62; B01D 17/0214

(57) ABSTRACT

A valve for draining a heavier liquid from a lighter liquid includes a valve body with an inlet and a drain outlet passing through a valve seat. A main float within the valve body seals the drain outlet when the level of the heavier liquid drops. An indicator assembly signals when the valve body is full of the heavier liquid. The indicator assembly includes an indicator float, an indicator element, and two magnets that interact via magnetic repulsion to cause a visible displacement of the indicator element as the indicator float rises and falls. A non-magnetic sealing partition maintains the sealed closure of the valve body while allowing magnetic interaction between the two magnets.

### FIELD AND BACKGROUND OF THE INVENTION

The present invention relates to valves, and more particularly to valves for separating immiscible liquids having different specific gravities.

Valves for separating immiscible liquids are commonly used in various industrial and commercial settings. These valves often rely on floats calibrated to differentiate between liquids based on their specific gravities. However, conventional valves lack a clear visual indication of the current liquid filling the valve body. This leaves the operator in doubt as to when a draining process needs to be initiated and may necessitate manual sampling of liquid from the top of the tank to assess the need for draining.

### SUMMARY OF THE INVENTION

The present invention is a valve for separating immiscible liquids and having a magnetically actuated indicator.

According to the teachings of an embodiment of the present invention there is provided, a valve for draining a quantity of a first liquid having a first specific gravity from a second liquid having a second specific gravity lower than the first specific gravity, the first and second liquids being immiscible, the valve comprising: (a) a valve body defining an internal volume, the valve body having an inlet and a drain outlet passing through a valve seat; (b) a main float disposed within the internal volume, the main float being configured to float on the first liquid and to sink in the second liquid, wherein the main float seals against the valve seat when a level of the first liquid within the internal volume drops below a predetermined level; (c) an indicator assembly for indicating when the internal volume is substantially full with the first liquid, the indicator assembly comprising: (i) an indicator float disposed within the internal volume and configured to float on the first liquid and to sink in the second liquid; (ii) an indicator element; (iii) a first permanent magnet coupled to the indicator float; and (iv) a second permanent magnet coupled to the indicator element; and (d) a non-magnetic sealing partition disposed between the first and second permanent magnets so as to maintain sealing closure of the valve body, wherein vertical motion of the indicator float causes, via magnetic repulsion between the first and second permanent magnets, a visible displacement of the indicator element.

According to a further feature of an embodiment of the present invention, the main float and the indicator float are guided along a common axis.

According to a further feature of an embodiment of the present invention, the main float is guided along a linear vertical path by at least one guide element.

According to a further feature of an embodiment of the present invention, the at least one guide element also guides motion of the indicator float.

According to a further feature of an embodiment of the present invention, the indicator element comprises a rod sliding within a glass tube encased in a metal tube, the metal tube having a side window for viewing the rod.

According to a further feature of an embodiment of the present invention, the metal tube is connected to a hollow bolt having a central channel within which the rod is disposed, the central channel being closed by the non-magnetic sealing partition, the hollow bolt being screwed into a threaded opening in a cover of the valve body.

According to a further feature of an embodiment of the present invention, the first permanent magnet is mounted on an upper side of the indicator float.

According to a further feature of an embodiment of the present invention, the first liquid is water and the second liquid is a hydrocarbon liquid.

According to a further feature of an embodiment of the present invention, the inlet is connected to the base of a hydrocarbon liquid storage tank.

According to a further feature of an embodiment of the present invention, the non-magnetic sealing partition is made of stainless steel.

According to a further feature of an embodiment of the present invention, a hollow bolt is screwed into a threaded opening in a cover of the valve body, the non-magnetic sealing partition closing an end of the hollow bolt.

### BRIEF DESCRIPTION OF THE DRAWINGS

The invention is herein described, by way of example only, with reference to the accompanying drawings, wherein:

FIG. 1 is an isometric view of a valve according to a first embodiment of the invention;

FIG. 2 is a cross-sectional view taken through the valve of FIG. 1 parallel to the central vertical axis of the valve;

FIG. 3 is an isometric cut-away view cut along the same plane as FIG. 2;

FIGS. 4A and 4B are partial enlarged cross-sectional views taken along a plane parallel to the central vertical axis of the valve but perpendicular to the plane of FIG. 2 showing the indicator assembly and associated components, where FIG. 4A shows the indicator float and indicator element in a lowered position and FIG. 4B shows them in a raised position;

FIGS. 5A and 5B are enlarged views of the regions of FIGS. 4A and 4B, respectively, designated “A” and “B”; and

FIGS. 6A and 6B are views similar to FIGS. 4A and 4B, respectively, showing a variant implementation of the indicator assembly.

### DESCRIPTION OF THE PREFERRED EMBODIMENTS

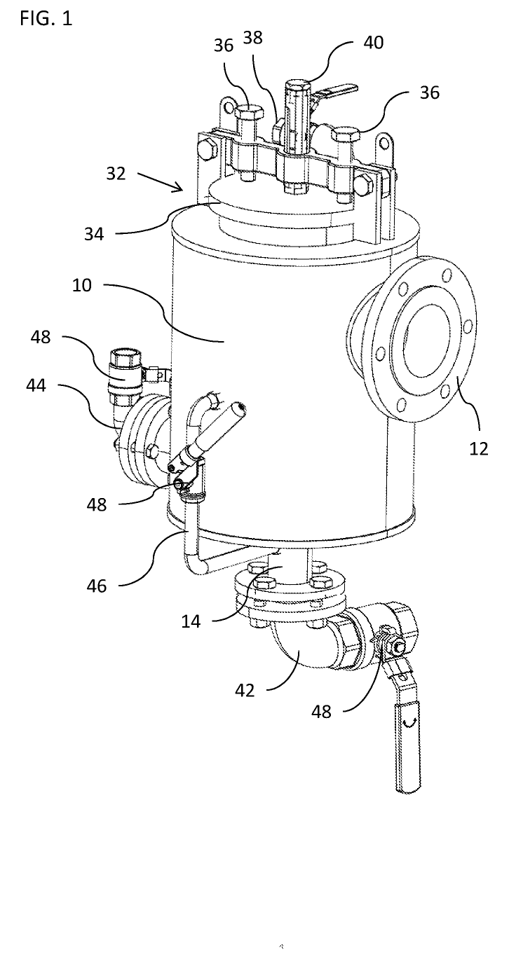

The present invention relates to an improved valve, such as may be used for draining a quantity of a first liquid having a first specific gravity from a second liquid having a second specific gravity lower than the first specific gravity, where the first and second liquids are immiscible. Referring to FIGS. 1-5B, a valve according to a first embodiment of the invention includes a valve body 10 defining an internal volume 11. The valve body has an inlet 12 and a drain outlet 14 passing through a valve seat 16. A main float 18 disposed within the internal volume is configured to float on the first liquid and to sink in the second liquid, wherein the main float 18 seals against the valve seat 16 when a level of the first liquid within the internal volume drops below a predetermined level.

The valve 10 further includes an indicator assembly for indicating when the internal volume is substantially full of the first liquid. The indicator assembly comprises an indicator float 20 disposed within the internal volume and configured to float on the first liquid and to sink in the second liquid, an indicator element 22, a first permanent magnet 24 coupled to the indicator float 20, and a second permanent magnet 26 coupled to the indicator element 22. A non-magnetic sealing partition 28 is disposed between the first and second permanent magnets 24, 26 so as to maintain sealing closure of the valve body, wherein vertical motion of the indicator float 20 causes, via magnetic repulsion between the first and second permanent magnets 24, 26, a visible displacement of the indicator element 22.

The phrase “substantially full” as used herein in the description and claims refers to a state where the internal volume of the valve is filled with the first liquid to an extent that the indicator float is lifted to its uppermost position, thereby actuating the indicator element. The internal volume being "substantially full" does not exclude the possibility of a residue of the second liquid trapped at the top of the internal volume.

The phrase “predetermined level” is used herein in the description and claims with reference to the level of the first liquid within the internal volume at which the main float closes the drain outlet. This phrase preferably refers to a level at which the internal volume is filled mainly with the second liquid, the level most preferably corresponding to the internal volume being more than 90% filled with the second liquid, but typically with sufficient residue of the first liquid to avoid accidental release of the second liquid.

“Coupled,” as used herein, refers to a direct or indirect connection between two elements that allows them to interact or influence each other's movement, such as by attachment, magnetic attraction, or other suitable means.

“Mechanically coupled,” as used herein, refers to a direct or indirect physical connection between two elements that allows them to interact or influence each other's movement, such as by rigid or flexible attachment, or by a magnetic attraction between the elements.

By way of one preferred but non-limiting example, the invention can be used to advantage in the context of a liquid hydrocarbon (e.g., fuel) storage system in which liquid hydrocarbon is stored in large tanks (not shown), typically covered by floating covers, into which rainwater typically penetrates. Since water is denser than the liquid hydrocarbon, it tends to sink to the bottom of the storage tank. The valve 10 is connected to the base of the storage tank so that any water can be drained off. The basic structure and operation of the valve 10 for this purpose is similar to that described in US Patent No. 5,918,622, but the present invention provides an improvement over the valve described in that document by providing an indicator assembly to indicate whether the internal volume is substantially filled with water and ready to be drained, or whether it contains predominantly liquid hydrocarbon.

In the absence of such an indicator, the operator may from time to time need to manually verify the contents of the internal volume. This can be achieved by opening the bleeder output pipe 38 and visually inspecting the liquid which emerges. However, this is inconvenient and potentially hazardous due to the flammability of the liquid hydrocarbon. The provision of the indicator assembly of the present invention advantageously avoids the need for such manual verification.

It is important that the valve 10 is well sealed in order to avoid leakage of the liquid hydrocarbon, which is both a safety hazard and an environmental concern. The indicator assembly of the present invention advantageously employs magnetic repulsion to transfer motion from the indicator float 20 to the indicator element 22 so as to avoid the need for any direct mechanical coupling or any sliding seals which could be prone to leakage.

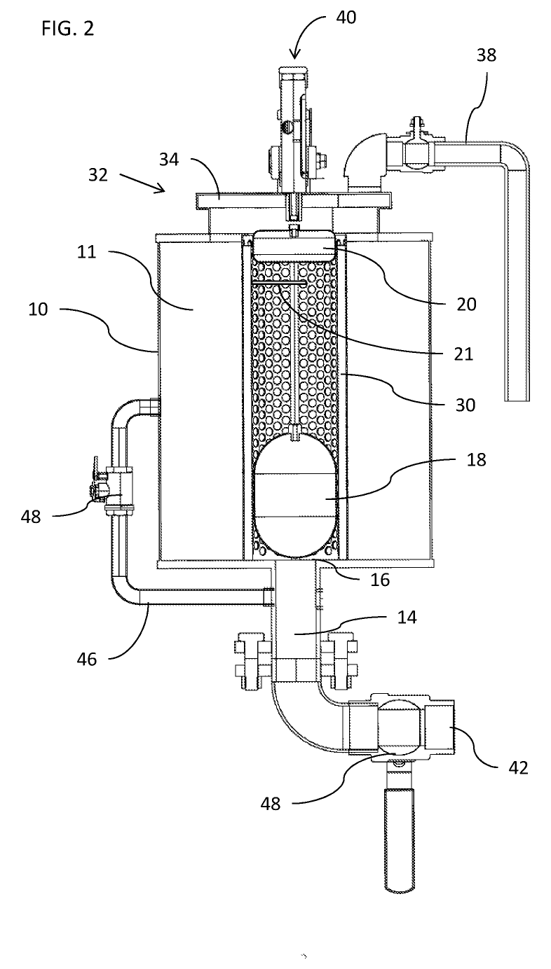

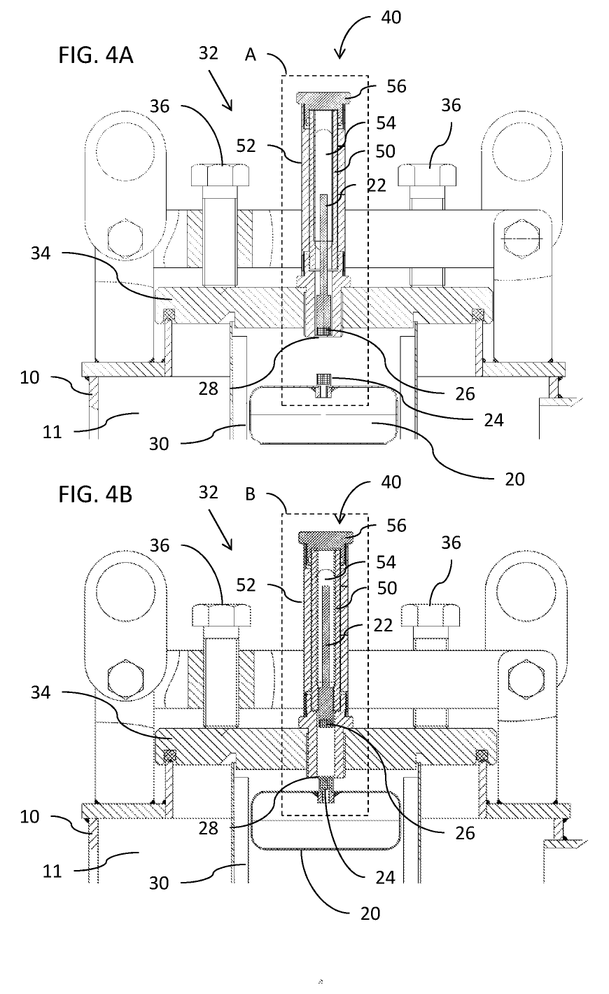

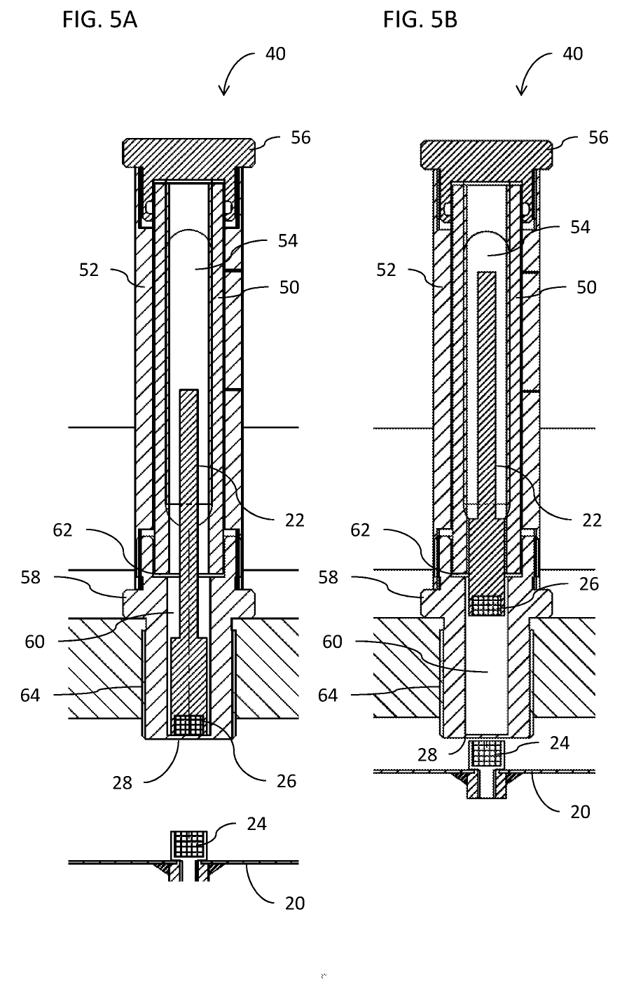

Referring now in particular to FIGS. 4A and 4B, there is shown a preferred implementation of the indicator assembly. FIGS. 4A and 4B are partial enlarged cross-sectional views taken along a plane parallel to the central vertical axis of the valve 10 but perpendicular to the plane of FIG. 2 showing the indicator assembly and associated components, where FIG. 4A shows the indicator float 20 and indicator element 22 in a lowered position and FIG. 4B shows them in a raised position. FIGS. 5A and 5B show enlarged views of the indicator tube assembly 40 in corresponding respective positions.

The indicator element 22 comprises a rod 22 sliding within a glass tube 50 encased in a metal tube 52, the metal tube 52 having a side window 54 for viewing the rod 22. The metal tube 52 is connected to a hollow bolt 58 having a central channel 60 within which the rod 22 is disposed, the central channel 60 being closed at some point along its length by the non-magnetic sealing partition 28, the hollow bolt 58 being screwed into a threaded opening 64 in a cover 34 of the valve body 10. The non-magnetic sealing partition 28, and typically the entire hollow bolt 58, is preferably made of stainless steel due to its corrosion resistance and compatibility with the other valve components. Stainless steel is also a preferred material for the entirety of the valve body, cover and metal tube 52.

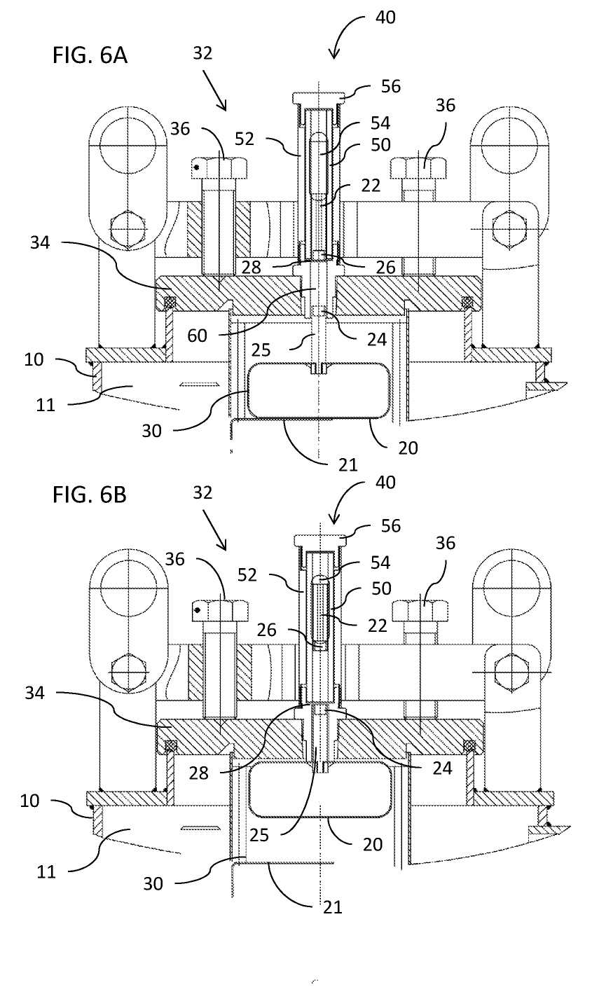

The first permanent magnet 24 is mounted on an upper side of the indicator float 20, either directly, as shown in FIGS. 4A-5B, or via a magnet support rod 25, as shown in FIGS. 6A-6B. The second permanent magnet 26 is mounted on a lower end of the indicator element 22 (i.e., rod 22). Optionally, a first part of rod 22 adjacent to second permanent magnet 26 may have a larger diameter than the upper part of rod 22 and be in close fitting sliding relation to the internal bore of the hollow bolt 58 and/or to the internal diameter of the glass tube 50 which abuts the internal shoulder 62 within the hollow bolt 58. The first and second permanent magnets 24, 26 are preferably relatively strong permanent magnets formed, for example, from an alloy of rare earth metals such as neodymium, samarium, and/or praseodymium. The magnets are deployed so as to generate repulsive magnetic forces between them, such as by aligning the north pole of one opposite the north pole of the other.

When the first liquid fills the valve body 10, either due to gravity flow alone or through operation of forced recirculation through recirculation pipe 44, indicator float 20 rises to the top of the internal volume. The first permanent magnet 24 then abuts the non-magnetic sealing partition 28 and, via magnetic repulsion, displaces the second permanent magnet 26 and the indicator element 22 to which it is attached upwards relative to the metal tube 52. This displacement is visible to an operator through the side window 54. A protective cap 56 is provided on the top of the metal tube 52 to protect the top of glass tube 50 and/or the top end of rod 22 and to prevent ingress of dirt.

Referring back to FIGS. 1-3, the valve body 10 is shown with an inlet 12 formed with a large flange for attachment to a large gauge pipe from the storage tank (not shown). A drainage pipe 42 emerges from the bottom of the valve 10 and is controlled by a manual tap 48. A smaller gauge recirculation pipe 44 emerges from the rear of the housing and is also controlled by a manual tap 48. A small pressure equalization bypass 46 extends from the wall of the main housing to the side of the drainage pipe 42 below the housing and is controlled by a manual tap 48. After a previous cycle in which main float 18 was closed against valve seat 16 at the end of a drainage process, the float is typically held against the valve seat by the static pressure of liquid in the main tank. Opening of the pressure equalization bypass 46 while the tap of the drainage pipe 42 is closed cancels the pressure differential on the main float, allowing it to rise through its buoyancy in the first liquid. At the top of the valve 10, there is a cover assembly 32 which includes a flat cover 34 clamped closed by two bolts 36, a bleeder output pipe 38 controlled by a tap 48, and the indicator tube assembly 40.

The main float 18 and the indicator float 20 are both guided along a common axis by a guide structure 30, which in this embodiment is a cylindrical perforated tube but may equally be implemented as other guide structures, such as a set of parallel vertical rods surrounding the floats. The main float 18 is configured to seal against the valve seat 16 when the level of the first liquid (e.g., water) within the internal volume drops below a predetermined level. The indicator float 20 is configured to rise to the top of the internal volume when the internal volume is substantially full of the first liquid. A float stop 21 is preferably deployed to prevent contact between the floats, defining an uppermost position of main float 18 and a lowest position of indicator float 20.

The main float 18 and the indicator float 20 are both typically implemented as hollow shells, typically of stainless steel, and may be coated with Teflon to reduce adherence of fuel. Since the required effective density/buoyancy of the floats 18, 20 is known in advance, it is a straightforward task to design the wall thickness of the floats 18, 20 (i.e., quantity of metal) vs. their volume to provide the required effective density intermediate between that of the two liquids.

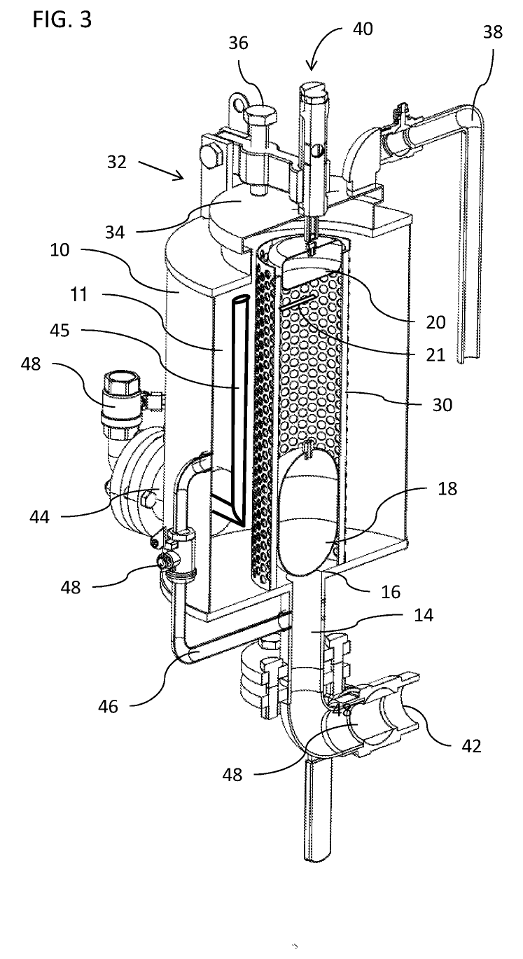

A recirculation pipe 44 with a recirculation pump (not shown) is provided to ensure the internal volume is properly primed with the first liquid prior to the start of a draining operation. As seen in FIG. 3, recirculation pipe 44 preferably has an intake tube 45 configured to draw liquid from near the top of internal volume 11, thereby facilitating return of the lighter second liquid to the main tank (not shown) while internal volume 11 fills with the first liquid that is to be drained.

A small pressure equalization bypass 46 controlled by a manual tap 48 is provided to equalize the pressure above and below the main float 18 after closure of the drain outlet 14 by the main float 18 and before the start of the next draining operation. This allows the main float 18 to rise from the valve seat 16 to the top of the internal volume when it is again filled with the first liquid.

Although the indicator assembly is shown in FIGS. 4A and 4B as being guided along the same vertical line of motion as the main float 18, in alternative implementations, the indicator assembly may alternatively be positioned so as to be off-axis relative to the main float 18.

It is further envisaged that the indicator float 20 may be guided in a different manner from the linear guide shown here. For example, indicator float 20 may optionally be mounted on a pivoting lever, similar to a float arrangement used in many flush toilets. The magnetic actuation of the indicator element would be operative in the same manner as described herein, with a magnet mounted on the float displacing the indicator element by magnetic repulsion when it reaches the top of its range of motion.

FIGS. 6A and 6B are generally parallel to FIGS. 4A and 4B but illustrate a variant implementation in which first magnet 24 is supported on a magnet support rod 25 instead of being mounted directly to indicator float 20. In this case, non-magnetic sealing partition 28 is located at an intermediate position along hollow bolt 58, typically at or near internal shoulder 62. In this case, a lower part of the central channel 60 serves as a guide channel for magnet support rod 25, providing additional guiding for motion of indicator float 20.

It will be appreciated that the above descriptions are intended only to serve as examples, and that many other embodiments are possible within the scope of the present invention as defined in the appended claims.

WHAT IS CLAIMED IS:

1. A valve for draining a quantity of a first liquid having a first specific gravity from a second liquid having a second specific gravity lower than the first specific gravity, the first and second liquids being immiscible, the valve comprising:
(a) a valve body defining an internal volume, the valve body having an inlet and a drain outlet passing through a valve seat;
(b) a main float disposed within the internal volume, the main float being configured to float on the first liquid and to sink in the second liquid, wherein the main float seals against the valve seat when a level of the first liquid within the internal volume drops below a predetermined level;
(c) an indicator assembly for indicating when the internal volume is substantially full of the first liquid, the indicator assembly comprising:
(i) an indicator float disposed within the internal volume and configured to float on the first liquid and to sink in the second liquid;
(ii) an indicator element;
(iii) a first permanent magnet coupled to the indicator float; and
(iv) a second permanent magnet coupled to the indicator element; and
(d) a non-magnetic sealing partition disposed between the first and second permanent magnets so as to maintain sealing closure of the valve body, wherein vertical motion of the indicator float causes, via magnetic repulsion between the first and second permanent magnets, a visible displacement of the indicator element.

2. The valve of claim 1, wherein the main float and the indicator float are guided along a common axis.

3. The valve of claim 1, wherein the main float is guided along a linear vertical path by at least one guide element.

4. The valve of claim 3, wherein the at least one guide element also guides motion of the indicator float.

5. The valve of claim 1, wherein the indicator element comprises a rod sliding within a glass tube encased in a metal tube, the metal tube having a side window for viewing the rod.

6. The valve of claim 5, wherein the metal tube is connected to a hollow bolt having a central channel within which the rod is disposed, the central channel being closed by the non-magnetic sealing partition, the hollow bolt being screwed into a threaded opening in a cover of the valve body.

7. The valve of claim 1, wherein the first permanent magnet is mounted on an upper side of the indicator float.

8. The valve of claim 1, wherein the first liquid is water and the second liquid is a hydrocarbon liquid.

9. The valve of claim 8, wherein the inlet is connected to the base of a hydrocarbon liquid storage tank.

10. The valve of claim 1, wherein the non-magnetic sealing partition is made of stainless steel.

11. The valve of claim 10, wherein a hollow bolt is screwed into a threaded opening in a cover of the valve body, the non-magnetic sealing partition closing an end of the hollow bolt.
